(19) United States
(12) Patent Application Publication
(10) Pub. No.: US 2017/0024542 A1
(43) Pub. Date: Jan. 26, 2017

(54) LOGGING SYSTEM AND A METHOD OF REGISTERING DATA FOR ENABLING MONITORING OF INTAKE OF A PRODUCT BY A USER ACCORDING TO AN INTAKE PLAN

(71) Applicant: KONINKLIJKE PHILIPS N.V., EINDHOVEN (NL)

(72) Inventors: ASHOKA SATHANUR VISWESWARA, EINDHOVEN (NL); SOTIR FILIPOV OUZOUNOV, EINDHOVEN (NL)

(21) Appl. No.: 15/106,338

(22) PCT Filed: Dec. 17, 2014
(86) PCT No.: PCT/EP2014/078141

§ 371 Date: Jun. 20, 2016

(30) Foreign Application Priority Data
Dec. 20, 2013 (EP) 13199023.6

(51) Int. Cl. G06F 19/00; G08B 21/04; G08B 25/12

(52) U.S. Cl. CPC G06F 19/3462; G06F 19/322; G08B 25/12; G08B 21/0446

(57) ABSTRACT

A logging system (200) and a method of registering data for enabling monitoring of intake of a product by a user according to an intake plan are provided. The logging system (200) comprises a dispensing device (220) for dispensing the product to the user who operates the dispensing device by manual interaction and a logging device (240). The dispensing device has identification data (ID) which identifies the device itself or identifies the product dispensed by the device. The dispensing device and the logging device are able to communicate via body coupled communication. When the dispensing device and the logging device are both in the close vicinity of the body of the user (110) who carries the logging device during said manual interaction, the identification data is transmitted via body coupled communication to the logging device which subsequently stores the received data in a data storage.

A logging system and a method of registering data for enabling monitoring of intake of a product by a user according to an intake plan

### FIELD OF THE INVENTION

The invention relates to systems and methods which enable the monitoring whether a user adheres to an intake plan.

### BACKGROUND OF THE INVENTION

Adherence to medication for chronic illness in developed countries averages 50%—this is even lower in developing countries. This is due to many patients having difficulty in following treatment recommendations and adhering to the prescribed medication. Particularly it is challenging for the elderly. Poor adherence to medication for long term therapies leads to poor health outcomes and increased health care costs.

Published patent application US2008/0149659 discloses a medication box which has compartments for storing medicines and comprises means to detect via RF signals whether a user device is within a certain distance from the medication box. The user device is, for example, a watch to be worn by a user and the watch is RF enabled such that the medication box is able to detect on basis of a received signal strength at what distance the user is present from the medication box. When the user is in the neighborhood of the medication box, the medication box is able to prompt the user to take his medicines at a predetermined moment in time according to an intake plan.

In the above disclosed system, the user is alerted to take his medicines when he is in the neighborhood of the medication box such that the user, hopefully, better adheres to a care plan which prescribes when specific medication must be taken. The system leaves the initiative to take the medication still at the user and it is not known whether the user actually took the medicines. A physician is not able to see whether the user adheres to the care plan.

EP 1798876 describes an operation state detection device which can detect an operation that an operator performs with respect to a person, for example an injector inserted by a nurse into a patient. The injector is provided with conductive material to form a current path via the arm of the nurse and various contact tags (e.g. on the injector, its container, the floor). The contact tags are data communication devices that communicate ID data via the current path to a communication device that is worn by the nurse and is collecting ID data of the tags are in contact with the nurse.

US 2009/0112178 describes a system for controlling a fluid port outside a patient's body by a parental device. The patient is provided with a receiver, and the fluid dispenser is provided with a transmitter. A conductive path is formed from the transmitter via the fluid to the body of the patient and to the receiver. The receiver detects a signal from the transmitter via the path.

### SUMMARY OF THE INVENTION

It is an object of the invention to provide a registration system which enables accurately monitoring whether the user adheres to an intake plan which prescribes when a user has to take a specific product.

A first aspect of the invention provides a logging system for enabling monitoring of intake of a product by a user according to an intake plan. A second aspect of the invention provides a method of registering data for enabling monitoring of intake of a product by a user according to an intake plan. Advantageous embodiments are defined in the dependent claims.

A logging system in accordance with the first aspect of the invention comprises a dispensing device and a logging device. The logging system is for monitoring of intake of a product by a user according to an intake plan. The dispensing device is configured to dispense a product to the user who operates the dispensing device by manual interaction and has identification data for transmission to the logging device. The identification data enables an identification of the dispensing device or an identification of the product that is dispensed by the dispensing device. In other words, the identification data identifies the dispensing device or identifies the product that is dispensed by the dispensing device. The dispensing device comprises a second body coupled communication interface for transmitting (identification) data via a body transmission channel following the body of the user. The logging device is arranged to be carried by the user on or in the close vicinity of the body of the user. The logging device comprises a first body coupled communication interface and a data storage. The first body coupled communication interface and the second body coupled communication interface are configured to capacitive couple to the body of the user during said manual interaction for communication via a body transmission channel. The data storage is configured to store received identification data for obtaining a log of received identification data for enabling monitoring of the intake of the product. The dispensing device is configured to transmit the identification data via body coupled communication, via the body transmission channel, to the logging device when the dispensing device and the logging device are both simultaneously in a close vicinity of the body of the living being.

The above provided system uses body coupled communication, which is communication via a body transmission channel, to accurately detect whether the user (almost) touched the dispensing device during said manual interaction to take the product (the product is, for example, medication and the dispensing device is in such a case, for example, an inhaler or the like) or to collect the product (when, for example, the dispensing device is a pill box or medication box). The logging device receives at the moment in time, at which the user was in the close vicinity of the dispensing device, the identification data and stores this information in the data storage optionally with the timestamp. The information stored in the data storage of the logging device provides accurate information to, for example, a physician or a monitoring system to determine whether the user follows an intake plan which prescribes that the product must be taken/consumed by the user. The product may be food, a drink or medication. The user may be a human being or an animal.

The above provided logging system is very accurate because the user has to come very close with (a part of) its body to the dispensing device before any registration is made in the logging device. The logging system is also accurate because, without interference of the user, events in which the user touches the dispensing device are registered. If the registration of the intake of product would require interference of the user, the user might try to influence the registration, or might forget to register the intake of the product. The way of registering events relating to the intake of the product of above described system fits the way a user has to act when he takes the product: when the product is a form of medication, he has to touch a medication box, or he has to bring an inhaler to his mouth, or he has to operate an injection device for injecting a medicine, etc. When the product is for example food or a liquid to drink, the user has to collect the food or use a dispensing device to collect the drink. In addition, the dispensing device identifies itself or identifies the product that is administers and, thus, the data stored in the data storage is also very accurate with respect to which product is taken. When the identification data identifies the dispensing device it may uniquely identify one specific dispensing device, or, for example, a type of dispensing device.

Furthermore, the above described logging system has its focus at the user which carries the logging device. The user carries the device which registers product intake events and no events are registered which relate to other user, for example, another person who also touches the medication box: the above described logging system only monitors events that relate to the user which carries the logging device because the body of the user forms the communication channel. Because the logging device and the dispensing device have to be in the close vicinity of the body of the user, it is very difficult to malicious parties or malicious devices to break into the logging system to influence, modify or delete registrations of the intake events. Such a malicious party or malicious device should also be in the close vicinity of the user and, as such, this user will most probably detect that something is not correct and will most probably undertake actions which prevent malicious parties and/or devices to break into the above described system. Carrying must be interpreted in this context as being (for a relatively long period) in the close vicinity of the body of the user. For example, a mobile phone may be carried in a pocket of trousers or a jacket that is worn by the person. In an embodiment, the logging device is a wearable device which is constructed to be worn by the user, such as, for example, a device at a necklace or a watch.

The identification data may be a name of a product, a registration number of the product, another uniquely assigned code to the specific product. When the product is, for example, a specific medication, the identification data may differ for pills, injection fluids, or fluids which are nebulized which have the same active compound, but which comprise different amounts of this compound. Alternatively, or in addition, the identification data may identify the dispensing device—identifying the dispensing device may be done by numbers and/or characters. (or a combination of both). A specific type of dispensing device may be identified, such as, for example, a water cooler of type x of manufacturer y, or, for example, an injection device of type z for injecting insulin, etc. Alternatively, each dispensing device which might be used in the logging system receives a unique identification number or code or name. The identification data may be hardcoded in the hardware of the dispensing device. The identification data may also be stored in a non-volatile memory of the dispensing device. Such identification data may be programmed in the dispensing device at the factory, or, for example by a doctor, a pharmacist or a salesman of the dispensing device.

It is to be noted that the body coupled communication interfaces are only able to communicate with each other when they are both in the close vicinity of the body. Close vicinity must be interpreted in this context as “close enough to each other such that the body coupled communication interfaces are able to capacitively couple to the body of the user”. In body coupled communication, the body coupled communication interfaces capacitively couple to the body of the user. The transmitting device generates a variable electric field which may be detected by the receiving device. In an embodiment, the close vicinity to the body is when the logging device or the dispensing device, respectively, are within 10 cm of the body of the user, or within 5 cm of the body of the user, or alternatively within 2 cm of the body of the user. Instead of “close vicinity” one may also read “direct vicinity”, and vice versa.

In the field of body coupled communication it is know how devices may detect whether another device is also in the close vicinity of the body of the user. For example, each individual device may comprise known technologies which detect whether they are in the close vicinity of the body of the user and, when the presence of a body of the user is detected, both device may transmit and detect at a predefined wavelengths beacon signals.

Optionally, the dispensing device is one of: a food dispensing device, a drink dispensing device or a medication dispensing device, such as, for example, a pill box, a medication box, an inhaler, a nebulizer, an injection device, an water cooler, a water tap, a coffee machine, a vending machine, a food distributing device.

Optionally, the logging device is one of: a watch, a mobile phone, a device attached to a necklace, an implantable device for implantation in a body of the user close to a body surface. The device that is being attached to the necklace is, for example, a small device with an alarm button which might be used by a patient to alarm a nurse, or to request assistance from a neighbor or family. The device that is being attached to the necklace may also be a device which automatically detects whether the user who carries the device fell and which automatically contacts via a network persons who might assist the user. When the logging device is the implantable device, it must be an implantable device which must be implanted close to the surface of the body of the user such that the body coupled interface being present in the implantable device is able to change the electrical field being present close to the skin of the user and able to detect changes of this electrical field. In other words, if it is an implantable device it must be a device that is arranged to be implanted in the body of the user at a location where the body coupled communication interface is able to capacitively couple to the electrical field available directly around the user.

Optionally, the controller of the logging device is further configured to detect whether the user adheres to the intake plan on basis of an assessment of the received identification data in relation to the intake plan. Thus, the controller is configured to analyze the stored identification data (optionally together with the timestamps being stored in the data storage) to detect whether the intake plan has been followed. The intake plan defines which product must be taken and may define which amount of the product must be taken. The intake plan may also prescribe how many times a day the product must be taken, or at which particular time which specific product must be taken. Note that the controller of the logging device may be configured to store the intake plan in the data storage.

Optionally, the logging device comprising an alerting element for alerting the user when the controller detects that the user does not adhere to the intake plan. The alerting element makes the user more aware of the fact that he forgot to take the product and when the user is more aware of his behavior it is expected that the user better adheres to the intake plan. The alerting element may provide a visual, audible or tactile signal to the user. The alerting element may be a display, a light emitter or a sort of loudspeaker with a driving circuit for generating the audible signal. The audible signal may be music, or a single note or tone, or spoken text, etc. The provided signal may also be a vibration of a vibration element.

In the context of animals, the animal may be trained to respond to a specific signal provided by the alerting element by going to a food or liquid dispenser.

In an optional embodiment, the logging device is configured to repeatedly provide the alert from the moment in time that the controller detected that the user does not adhere to the intake plan until a subsequent moment in time that identification data is received from the dispensing device. Thus, the alert is provided several times and the providing of the alert only stops when the living being uses the dispensing device. Thereby a better adherence to the intake plan may be expected. The controller of the logging device may control the repeating alerts. In a more advanced embodiment, the subsequent moment in time is a moment in time that the logging device receives identification data which identifies a specific product that the user did not take in according to the intake plan.

Optionally, the adherence system further comprises a network interface for connecting to a network (which is a different network from a communication network which is based on the body coupled communication via the body of the user, thus, the network is not based on body coupled communication) for allowing another device to access the data storage of the logging device or for sending a signal to the another device. The network interface is provided in the logging device or in a communication device that also comprises a third body coupled communication interface. The third body coupled communication interface is also configured to capacitive couple to a body of the user for communication via the body transmission channel. Thus, the network interface provides a communication channel which ranges further than the body of the user alone. Thereby the information stored in the logging device or generated within the logging device may be communicated to devices which are not in the direct vicinity of the body of the user and such devices may communicate information for storage or processing in the logging device. When the communication device comprises the network interface, the communication device must also be able to communicate with the logging device via body coupled communication and, therefore, the communication device comprises the third body coupled communication interface.

Optionally, the logging system comprises a remote device which is configured to enable detecting whether the user adheres to the intake plan by a) communicating with the logging device via the another network and b) uploading an intake plan to the logging device and/or receive data stored in the data storage of the logging device or being generated within the logging device.

Optionally, the remote device also comprises a user interface, the user interface comprises a display for presenting received data to a specific person and/or an input device for receiving the intake plan from the specific person. Thus, via the remote device the specific person, such as a physician, or a family member, is able to monitor how the user, who carries the logging device, adheres to the intake plan, and, additionally, the specific person may upload a new intake plan to the logging device (which may be used by the logging device to control the adherence of the user to the intake plan).

Optionally, the logging device also comprises an alarm button or a fall sensor for detecting whether the user who carries the logging device falls, and the controller is further configured to send via the network interface an alarm signal to one or more remote devices when the user pushes the alarm button and/or when the fall sensor detects that the user fell. Thus, the logging device has further functions which relate to the monitoring of the well-being of the user. The user is, for example, a person and the alarm button may, for example, be operated by the person when the person needs assistance from a nurse or physician. The fall sensor is able to detect whether the user, who has the fall sensor attached to his body, falls and the controller is able to generate a signal to warn someone who is able to assist the user.

Optionally, the controller of the logging device is further configured to store a time stamp with the received identification data in the data storage. Having a list of timestamps with identification data provides very accurate information about the use of product by the user. The time stamp may originate from an internal clock of the logging device (and indicates at which moment in time the identification data was received by the logging device) or from an internal clock of the dispensing device (which information is than transmitted together with the identification data to the logging device). The time stamp may relate to time only, date only, or both time and date.

Optionally, the dispensing device comprises a sensor for sensing whether the product is dispensed. The dispensing device is further configured to provide via the second body coupled communication interface dispensing data about the dispensing of the product on basis of information from the sensor. The controller of the logging device is further configured to receive via the first body coupled communication interface the dispensing data sent by the dispensing device, and to store the received dispensing data in the data storage. In an embodiment, the dispensing data is stored together with the identification data and optionally with a time stamp. Thus, the data stored in the data storage does not only relate to the fact that the user was with his body in the close vicinity of the dispensing device (and, thus, most probably the user consumed the product), but also relate to the fact whether the dispensing device dispensed the product. The information whether the dispensing device actually dispensed the product is a more reliable indication of the fact that the user consumed the product. The more reliable the information that is being stored in the data storage of the logging device is, the more accurately the adherence of the user to the intake plan may be monitored. For example, when the dispensing device is a pill box, the pill box may detect whether some compartments are opened, and/or the pill box may detect whether pills are removed from the compartments. When the medication dispensing device is, for example, an inhaler, a sensor may detect whether inhaler is used and, thus, whether medication is dispensed. It is to be noted that the dispensing information may also be used by the controller to decide whether the user adheres to the intake plan. The dispensing information may also be transmitted to remote device when the remote device connects via the another network to the logging device to enable the remote device to present the dispensing data to, for example, a doctor, a physician, other medically trained personnel, a family member or a caretaker.

Optionally, the sensor of the dispensing device is further configured to detect which amount of product has been dispensed and the dispensing data comprises information based on the detected amount. Thus, even more reliable information is collected and stored in the data storage such that an even better monitoring of the adherence to the intake plan is made possible. For example, when the dispensing device is a pill box, the sensed amount may relate to the number of pills removed from the compartments, or may even relate to the combination of the number of pills removed from the compartment and the amount of the active compound in the respective pills. For example, when the dispensing device is an inhaler, the amount of dispensed medication may indicate the amount of the active compound that was dispensed.

Optionally, the data storage of the logging device stores a user's identification data which uniquely identifies the user who owns or carries the logging device. The logging device is configured to provide the user's identification data to another device via the first body coupled communication interface. The dispensing device is further configured to a) store access data that identifies a user who is allowed to use the dispensing device, b) receive via the second body coupled communication interface the user's identification data when the body of the user is simultaneously in the close vicinity of the logging device and the dispensing device, and c) only dispense the product when an assessment of the received user's identification data in the light of the access data reveals that the user is allowed to use the dispensing device. This optional embodiment provides security with respect to unauthorized intake/use of the product, which might be very relevant when the product is medication. It might be dangerous when someone else, who does not have to use the medication dispensed by the medication dispensing device, is able to retrieve the dispensed medication. This is prevented by identifying the user who owns the logging device to the dispensing device. The assessment of the received user's identification data in the light of the access data may comprise comparison steps wherein the user's identification data and the access data is compared, and may comprise additional authentication algorithms or functions when the user's identification data is not by definition exactly equal to the access data when the user is allowed to use the dispensing device.

Optionally, the first body coupled communication interface is configured to communicate with other devices via a body transmission channel following the body of the user when the first body coupled communication interface is in a close vicinity of the body of the user. Optionally, the second body coupled communication interface is configured to communicate with the logging device via the body transmission channel following the body of the user when the first body coupled communication interface and the second body coupled communication interface are in a close vicinity of the body of the user. Optionally, the third body coupled communication interface is configured to communicate with the logging device via the body transmission channel following the body of the user when the first body coupled communication interface and the third body coupled communication interface are in a close vicinity of the body of the user.

Optionally, the logging system further comprises an alerting device which comprises also a body coupled communication interface. When the user is with his body simultaneously in the close vicinity of the logging device and the alerting device, the alerting device communicates via the body coupled communication interface with the logging device to obtain information from the logging device in relation to the intake of the product. Such information may comprise the information that is stored in the data storage or may be information that is being generated by the controller of the logging device (for example, whether the user adheres to the intake plan). Such information may also be the intake plan when the intake plan is stored on the logging device. The alerting device may be configured to alert the user that he has to take the product, when, on basis of the received information, a controller of the alerting device is able to determine that the user forgot to take the product or when the controller of the alerting device is able to determine that the product must be taken in the near future. The controller of the alerting device may also comprise analysis functions for analyzing whether the user adheres to the intake plan. The alerting device may also suggest to the user which product must be taken, but in a simple embodiment, the alerting device only provides a relatively simple audible or visual signal to the user. The alerting device also comprises an alerting element of which embodiments have already been discussed above in the context of the alerting element of the logging device. The alerting device may also be the device which comprises the network interface. An embodiment of the alerting device is a mobile phone, a laptop, a tablet computer. In another embodiment, the alerting device is a dedicated device which only performs the above discussed functions.

According to another aspect of the invention a method of registering data for enable monitoring of intake of a product by a user. The method comprises the stages of: a) storing in a data storage of a logging device an intake plan, b) detecting whether the logging device and a dispensing device are both in the close vicinity of a body of the user, c) communication identification data from the dispensing device to the logging device when both devices are in the close vicinity of the body of the user; the communicating is perform via body coupled communication interfaces being present in both device; the identification data identifies the product being dispensed by the dispensing device or identifies the dispensing device, the body coupled communication interfaces capacitively couple to a body of the user for communicating the identification data; and d) storing the identification data in the data storage of the logging device.

The above discussed method provides the same benefits as the adherence system according to the first aspect of the invention and has similar embodiments with similar effects as the corresponding embodiments of the system.

According to a further aspect of the invention, a distributed computer program is provided which comprises instructions for causing processor systems to perform the stages of the above discussed method. A distributed computer program is partly present on one device and partly preset on another device, such as, in this application, the logging device and the dispensing device.

According to yet another aspect of the invention, a dispensing device for use in a logging system as discussed above is provided. The dispensing device is for dispensing a product. The dispensing device comprising a second body coupled communication interface for transmitting data via a body transmission channel and having identification data for transmission to a logging device. The identification data enabling an identification of the dispensing device or an identification of the product being dispensed by the dispensing device. The dispensing device being configured to transmit the identification data via a body transmission channel to the logging device when the dispensing device and the logging device as carried by the user are both in a close vicinity of the body of the user. The dispensing device may have embodiments in line with embodiments of the dispensing device of the earlier discussed logging system.

According to yet a further aspect of the invention, a logging device for use in a logging system as discussed above is provided. The logging device is arranged for being carried by a user on or in the close vicinity of a body of the user and the logging device comprises a first body coupled communication interface for receiving identification data and comprises a data storage. The data storage is configured to store received identification data for obtaining a log of received identification data for enabling monitoring of the intake of the product.

These and other aspects of the invention are apparent from and will be elucidated with reference to the embodiments described hereinafter.

It will be appreciated by those skilled in the art that two or more of the above-mentioned options, implementations, and/or aspects of the invention may be combined in any way deemed useful.

Modifications and variations of the system, the method, which correspond to the described modifications and variations of the system, can be carried out by a person skilled in the art on the basis of the present description.

### BRIEF DESCRIPTION OF THE DRAWINGS

In the drawings:

FIG. 1 schematically shows an embodiment of a medication adherence system,

FIG. 2 schematically shows another embodiment of a medication adherence system,

FIG. 3 schematically presents several embodiments of personal devices and medication dispensing devices,

FIG. 4 schematically presents a method of registering data according to the second aspect,

FIG. 5 schematically presents a first embodiment of the logging system, and

FIG. 6 schematically presents a second embodiment of the logging system.

It should be noted that items denoted by the same reference numerals in different Figures have the same structural features and the same functions, or are the same signals. Where the function and/or structure of such an item have been explained, there is no necessity for repeated explanation thereof in the detailed description.

The Figures are purely diagrammatic and not drawn to scale. Particularly for clarity, some dimensions are exaggerated strongly.

### DETAILED DESCRIPTION OF THE EMBODIMENTS

It is to be noted that in the subsequent embodiments of the logging system some terms are used which are species of terms used in the claims. For example, a “medication adherence system” is a species of the “logging system”. The “person” is a species of the general term “user”. “Medication” is the species of the general term “product”. Furthermore, the “medication dispensing device” is a species of the general term “dispensing device”. The “personal device” or “wearable device” is a specific embodiment of the “logging device”.

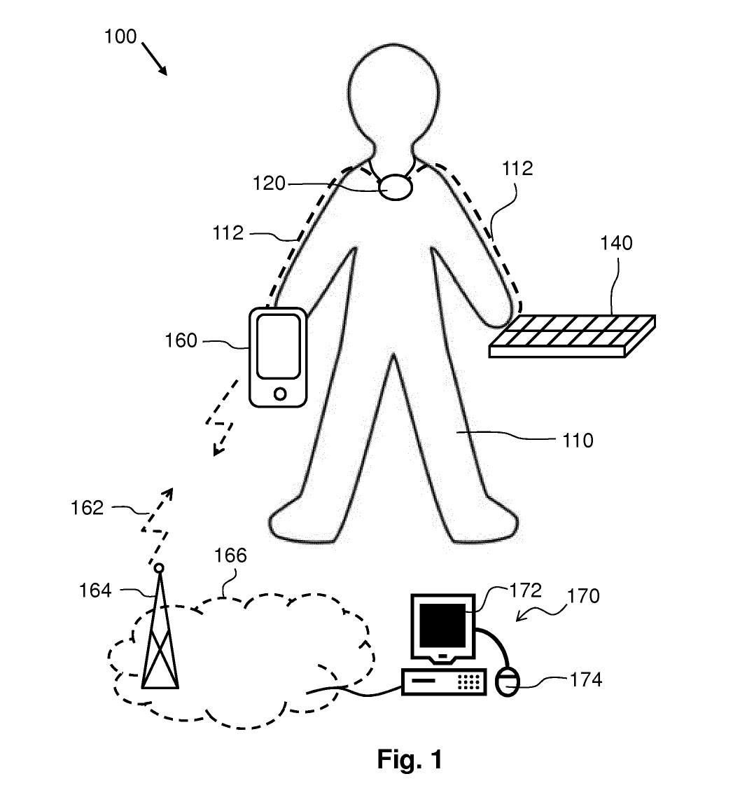

A first embodiment of a medication adherence system 100 is shown in FIG. 1. The medication adherence system 100 comprises a personal device 120 and a medication dispensing device 140. Optional devices in this medication adherence system 100 are a mobile phone 160 and a remote device 170.

The personal device 120 is for example a small device that can be worn with a necklace around the neck of the person 100 who owns the personal device 120. Because the personal device 120 is worn around the neck, the personal device 120 is in the direct, or, in other words, close vicinity of a body of the person 110. The personal device 120 at least comprises a first body coupled communication interface (not shown), a data storage (now shown) and (optionally) a controller (not shown).

The first body coupled communication interface of the personal device 120 is configured to communicate via the body of the person 110 with other devices which are in the close vicinity of the body of the person 110. Such communication is termed “body coupled communication”. In general, the body coupled communication interface comprises an electrical conductive plate which is capacitively coupled with the body of the person 110. When the body coupled communication interface is used to transmit signals, the electrical conductive plate and the capacitive coupling is used to generate a variable electrical field around the body of the person. When the body coupled communication interface is receiving signals, it senses with the electrical conductive plate and a receiving circuitry how the electrical field around the body of the person varies and thereby it is able to receive the signal that has been transmitted by another device that is in the close vicinity of the body of the person. Thereby the body of the person 110 forms a body transmission channel 112. Other devices which are in the close vicinity of the body may also have such a body coupled communication interface which has the same or similar functions and characteristics. Only other devices which are in the close vicinity of the body of the person 110 can transmit or receive data via the body transmission channel. More information about body coupled communication may be found in other documents, such as, for example, US patent U.S. Pat. No. 6,211,799 or U.S. Pat. No. 5,914,701. It is to be noted that “close vicinity” means in the context of body coupled communication that the body coupled communication interface is able to capacitively coupled to the body of the person 110 and that signals may be transmitted via or received from the body. In an embodiment, “in the close vicinity of” means that the distance between a specific device and the body of the person 110 is smaller than 8 centimeter or smaller than 3 centimeter, or even smaller than 1 centimeter.

The data storage of the personal device 120 is configured to store data which is provided by the controller. The controller of the personal device 120 is configured to receive via the first body coupled communication interface identification data that is transmitted by the medication dispensing device 140 when the medication dispensing device 140 and the personal device 120 are both simultaneously in the direct vicinity of the body of the person 110. The controller is further configured to store the receive identification data in the data storage.

The medication dispensing device 140 is a device which is suitable for dispensing medication, such as pills, liquid medicines, medicines which must be nebulized in air, etc. In the example of FIG. 1, the medication dispensing device 140 is a pill box which comprises different compartments which may contain one or more specific pills for the person 110. The different compartments store one or more pills for specific moments in time that the person 110 must take the one or more pills. The medication dispensing device 140 is assigned identification data which identifies the medication dispending device 140 or identifies the medication that is being dispensed by the medication dispensing device 140. The identification data is, for example, hardcoded in the hardware of the medication dispensing device 140 or is stored in a non-volatile data storage element. The medication dispensing device 140 also comprises a second body coupled communication interface (not shown). The medication dispensing device 140 is at least configured to transmit the identification data to the to the personal device 120 via the second body coupled communication interface, and, thus, via the body of the person 110, to the personal device 120 when both the personal device 120 and the medication dispensing device 140 are at the same moment in time in the close vicinity of the body of the person 110. The above medication adherence system 100 provides means to accurately register in the data storage of the personal device when the person 110 touched (or was very close to) the medication dispensing device 140. The event that the person 110 touched the medication dispensing device 140 is a clear indication that the person most probably took the medication. Therefore, when these events are registered in the data storage of the personal device, an accurate logbook is created which enables the person 110, or another person, or an algorithm, to monitor whether the person 110 adheres to the medication intake plan.

Optionally, the medication adherence system 100 also comprises a mobile phone 160 (or any other device which can be worn close to the body of the person 110) which comprises a third body coupled communication interface (not shown) for communication with the personal device and which comprises an additional network interface (not shown) for connecting to another network 166. The another network 166 may also be used to transmit a signal that is generated in the personal device 120 may be transmitted to, for example, a remote device 170 or via which, for example, may allow the remote device 170 to contact the personal device 120 (and, thereby, access the data storage of the personal device). The mobile phone comprises, for example, the additional network interface that is capable of transmitting and receiving wireless signals 162 of a wide area, or local area, wireless network. In FIG. 1 it has been schematically indicated by antenna 164 that the another network 166 is, for example, a wide area wireless network. It is to be noted that, instead of the mobile phone 160, the personal device 120 itself may comprise the additional network interface which allows, for example, the remote device 170 to access the data storage of the personal device. In another embodiment, the mobile phone 160 is a watch which comprises the third body coupled communication interface and the additional network interface. It is to be noted that the term “another” is used in “the another network 166” because a body coupled communication network may also co-exist between the devices that are in the close vicinity of the body of the person 110. The another network 166 is, for example, a GPRS, EDGE, UMTS, HSDPA or LTA based wide area network, but may also be a WIFI network of a home, an office, or an hospital.

Optionally, the medication adherence system 100 comprises the remote device 170 which may access the data storage of the personal device 120 via the another network 166 or which may receive data or a signal from the personal device 120 via the another network 166. The remote device 170 may comprise a display 172 on which data is presented that has been stored in the data storage of the personal device 120, such as the identification data of the medication dispensing device, or other data stored in the data storage. In subsequent embodiment more information is provided about possible data that might be stored in the data storage of the personal device 120. The remote device 170 may also comprise an input device 174 such as, for example, a mouse and/or a keyboard which may be used by a user to input a medication intake plan which might, subsequently, be uploaded to the data storage of the personal device 120. The remote device 170 also comprise a network interface which is coupled directly, or indirectly, to the another network 166.

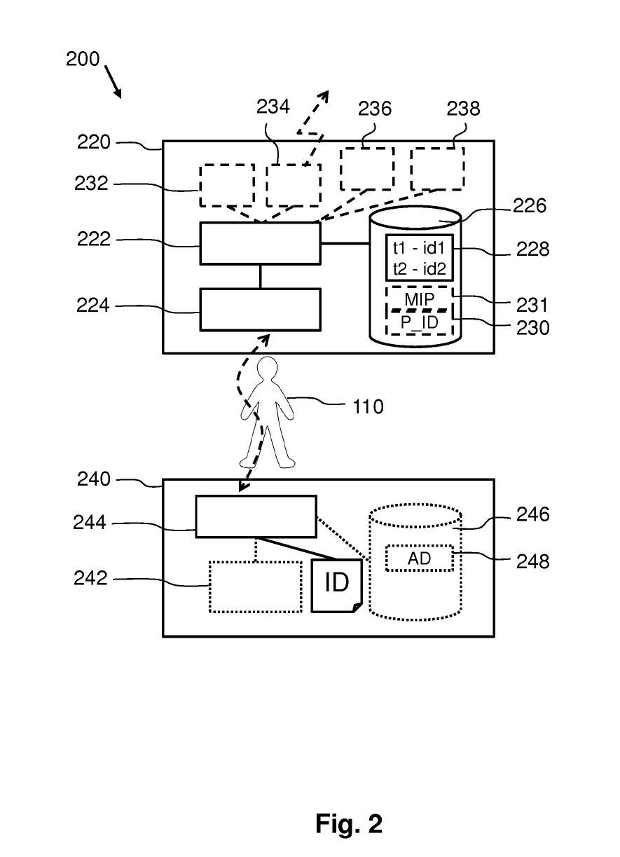

FIG. 2 presents more in detail a medication adherence system 200 which also comprises a personal device 220 and a medication dispensing device 240. In the middle of FIG. 2 the person 110 is drawn. The person 110 carries the personal device 220 and the person 110 may become with his body in the direct or close vicinity of the medication dispensing device 240.

The medication dispensing device 240 comprise at least means to dispense medication (now shown) and comprises a second body coupled communication interface 244 having characteristics of the body coupled communication interfaces that have been discussed in the context of FIG. 1. The medication dispensing device 240 is assigned with specific identification data ID which is, for example, stored in a memory of the medication dispensing device 240. The medication dispensing device 240 may be configured to detect when a body of a person is in the close vicinity and may subsequently transmit via the second body coupled communication interface 244 the identification data ID to other devices which are also in the close vicinity of the body of the person 110—such other device may be the personal device 220. In another embodiment, when the medication dispensing device 240 detects the presence of a body of a person in the close vicinity of the device 240, the second body coupled communication interface 244 may also start an procedure to find the personal device 220 and set up a network connection or a secure communication connection between the personal device 220 and the medication dispensing device 240 and, thereafter, the identification data ID is transmitted to the personal device 240.

The personal device comprises 220, as discussed in the context of FIG. 1, a first body coupled communication interface 224, a controller 222 and a data storage 226. The first body coupled communication interface 224, the controller 222 and the data storage 226 have at least the functions and characteristics as discussed in the context of FIG. 1. The controller 222 receives from the first body coupled communication interface 224 identification data that has been transmitted by the medication dispensing device 240 and stores the received identification data in the data storage 226. The data storage 226 may comprise, for example, a table 228 of sequentially stored identification data. Optionally, the controller 222 is also configured to store a timestamp together with the received identification data. The timestamp may originate from an internal clock (not shown) of the personal device or of the medication dispensing device. The timestamp indicates when the personal device 220 received the identification data or, when the timestamp originates form the medication dispensing device 240, at which moment in time the person 110 was in the close vicinity of the medication dispensing device 240. When the controller 222 also stores timestamps together with the identification data, the table 228 comprises, for examples, pairs of timestamps t1, t2 and identification data id1, id2.

Optionally, the data storage 226 also stores a medication intake plan MIP in an appropriate data format. The medication intake plan prescribes which medication must be taken, and optionally prescribes how much medication must be taken and/or at which moments in time how much of the medication must be taken. The controller 222 may also be configured to analyze the stored identification data (as, for example, stored in table 228) in relation to the stored medication intake plan 231, MIP to detect whether the user adheres to the medication intake plan MIP. The personal device optionally comprises an alerting element 232 which provides, when the controller 222 detects that the person 110 does not adhere to the medication intake plan MIP, a signal to the person. The signal may be visual, e.g. by means of light or, for example, a text presented on a display. The signal may be audible, such as a beep, some music, or spoken text. The signal may also be provided by a vibration element. Thus, the alerting element 232 may comprise a display, a light emitter, a loudspeaker, or a vibration element, etc. In an embodiment, the personal device 200 is configured to repeatedly provide the alert from the moment in time that the controller 222 detected that the person 110 does not adhere to the medication intake plan until a subsequent moment in time that identification data is received from the medication dispensing device 240. Thus, the alert is provided several times and the providing of the alert only stops when the person 110 uses the medication dispensing device 240. Thereby a better adherence to the medication intake plan 231, MIP may be expected. The controller 222 of the personal device 220 may control providing of the repeating alerts by informing a control signal to the alerting element 232 at repeated moments in time. In a more advanced embodiment, the subsequent moment in time is a moment in time that the personal device 220 receives identification data which identifies a specific medication that the user did not take in according to the medication intake plan.

As discussed above, the personal device 220 may optionally comprise a network interface 234 which is able to connect to another network (which is not based on transmission of signals via the body transmission channel), such as the another network 166 of FIG. 1. The controller 222 may receive via the network interface 234 requests from other devices (such as the remote device 170 of FIG. 1) to access the data in the data storage 226 and the controller 222 may provide access to the data storage 226. The controller 222 may also receive via the network interface 234 updates of the medication intake plan MIP and store these updates in the data storage 226. As discussed previously, the network interface 234 may also be provided in another device that is also able to communicate via the body of the person 110 with the personal device 220.

Optionally, the personal device 220 comprises an alarm button 236 which may be operated by the person 110 at moment in time when the person 110 needs assistance or wants to alarm someone. When the user pushes the alarm button 236, the controller 222 generates and alarm signal and transmits this alarm signal via an appropriate communication channel to other devices and/or other persons. Such an appropriate communication channel may be provided by the network interface 234 such that the alarm signal is, for example, transmitted to the remote device 170 of FIG. 1. Optionally, the personal device 220 comprises a fall sensor 238 which detects whether the person 110, who carries the personal device 220, fell. If the person 110 fell, the controller 222 generates a fall alarm signal and transmits this fall alarm signal via the appropriate communication channel to other devices and/or other persons.

Optionally, the data storage 226 of the personal device 220 also stores person's identification data 230, P_ID. This data may uniquely identify the person 110 who owns and/or carries the personal device 220. The personal device 220 may be configured to communicate the person's identification data P_ID, or data that is derived from this data, to the medication dispensing device 240 when both the medication dispensing device 240 and the personal device 220 are in the close vicinity of the body of the person 110. The medication dispensing device 240 may store in a second data storage 246 access data 248, AD which defines which person or which persons are allowed to use or access the medication being dispensed by the medication dispensing device 240. The medication dispensing device 240 may be configured to assess the received person's identification data P_ID (or data that is obtained from this data) in relation to the access data 248, AD to decide whether the person 110 is allowed to access the medication. In this optional embodiment, the medication dispensing device 240 is also configured to only dispense the medication when the assessment reveals that the person 110 is allowed to use or access the medication.

Optionally, the medication dispensing device 240 comprises a dispensing sensor 242 which detects whether the medication dispensing device 240 dispensed the medication. For example, when the medication dispensing device 240 is a pill box, the dispensing sensor 242 may be configured to detect whether the person 110 opened a compartment and/or whether the person 110 took a pill form one of the compartments. For example, when the medication dispensing device 240 is an inhaler that must be operated by a manual interaction of the person 110, the dispensing sensor 242 may detect whether the user operated the inhaler accordingly. On basis of the dispensing sensor 242 detections, the medication dispensing device 240 generates dispensing data which is transmitted together with the identification data to the personal device 220 which subsequently stores all received information, optionally with a timestamp, in the data storage. The dispensing sensor 242 may also be configured to detect the amount of medication that is being dispensed and this detected amount may also be comprised in the dispensing data.

It is to be noted that the data storage 226 of the personal device 220 and/or the second data storage 246 of the medication dispensing device 240 may be any form of hardware which is suitable for storing data. Thus, when power is guaranteed, it may be volatile memory. Or it may be non-volatile memory, or it may be a miniature hard disk.

It is further to be noted that, although not discussed in the above description, the medication dispensing device 240 may also comprise a second controller for controlling all communication between all different elements of the medication dispensing device 240 and/or for operating specific algorithms (such as, for example, the assessment of received person's identification data P_ID in relation to stored access data AD). The controller 222 of the personal device 220 and/or the second controller of the medication dispensing device 240 may comprise dedicated hardware developed to perform the above discussed functions and tasks of the respective controllers 222. Alternatively, the controller 222 of the personal device 220 and/or the second controller of the medication dispensing device 240 may comprise a general purpose processor system which is provided with a specific computer program which comprises instructions to perform the above discussed functions and tasks of the respective controllers 222.

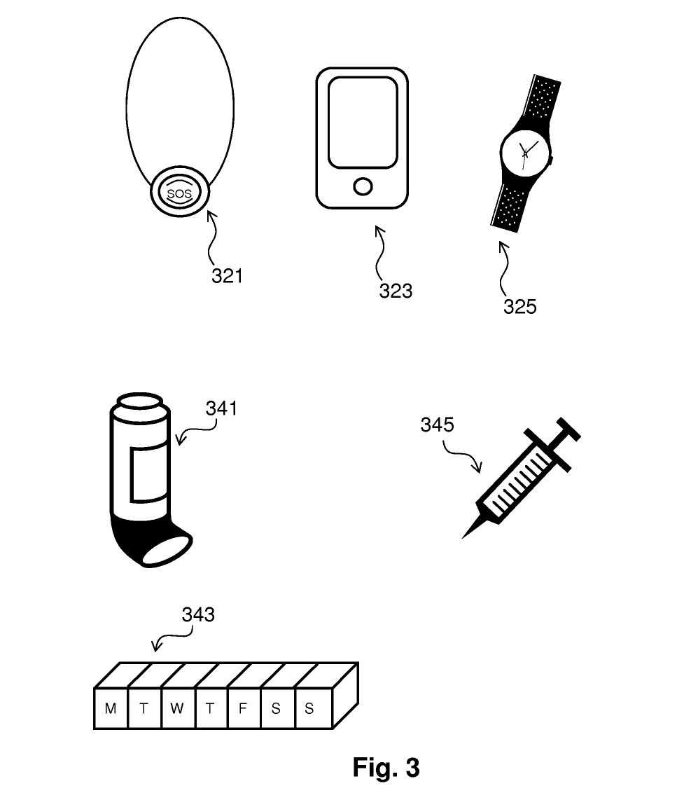

Optionally, the medication adherence system 200 further comprises an alerting device (not shown) which comprises also a body coupled communication interface. When the user is with his body simultaneously in the close vicinity of the personal device and the alerting device, the alerting device communicates via the body coupled communication interface with the personal device to obtain information from the personal device in relation to the intake of medication. Such information may comprise the information that is stored in the data storage 226 in, for example, table 228 or may be information that is being generated by the controller 222 of the personal device 200 (for example, whether the person 110 adheres to the medication intake plan 231, MIP). Such information may also be the medication intake plan 231, MIP when the medication intake plan 231, MIP is stored on the personal device 220. The alerting device may be configured to alert the person 110 that he has to take his medication, when, on basis of the received information, a controller of the alerting device is able to determine that the person forgot to take his medication or when the controller of the alerting device is able to determine that medication must be taken in the near future. The controller of the alerting device may also comprise analysis functions for analyzing whether the person adheres to the medication intake plan (in line with embodiments of the controller 222 of the personal device 200 that are discussed above). The alerting device may also suggest to the person 110 which medication must be taken, but in a simple embodiment, the alerting device only provides a relatively simple audible or visual signal to the person. The alerting device also comprises an alerting element of which embodiments have already been discussed above in the context of the alerting element 232 of the personal device 220. The alerting device may also be the device which comprises the network interface. An embodiment of the alerting device is a mobile phone (e.g. mobile phone 160 of FIG. 1), a laptop, a tablet computer. In another embodiment, the alerting device is a dedicated device which only performs the above discussed functions. FIG. 3 schematically presents several embodiments of personal device 321, 323, 325 and several embodiments of medication dispensing device 341, 343, 345. The personal device may be embodied in a watch 325, a mobile phone 323 (or, for example, portable music player) or a necklace with, for example, an alarm device 321 (comprising, for example, an alarm button and/or a fall sensor and the alarm device 321 must be worn constantly by a patient around his neck). Examples of medication dispensing devices are: an inhaler 341, a nebulizer (now shown separately), an injection device 345 such as, for example, an injection needle, or a pill/medication box 343. In order to detect whether medication is taken, the inhaler 341 may detect whether a user inhaled air through the inhaler 341 and may optionally detect how much air is inhaled and how much medication is provided in the inhaled air. The injection needle 345 may comprise a sensor to detect whether fluid flows through the needle and, optionally, which amount flew through the needle. The injection needle 345 may also comprise a sensor to sense whether the needle was inserted in the skin of a person (or even, the skin of the person carrying the personal device). The medication dispensing device may also be a pill or medication box 343. A pill or medication box 343 comprises, in general, several compartments in which pills for specific days are provided or even pills for specific moments of the day. The pill or medication box 343 may detect whether a compartment is opened, which specific compartment is opened, and may optionally detect whether one or more pills are removed from the specific compartment. The pill or medication box 343 may further comprise a controller and/or a data storage. In such a data storage information may be stored about which pill are present in which compartment, and, thus, depending on a specific compartment that is being opened, the controller may generate identification data that identifies the medication that was present in the compartment that is being opened.

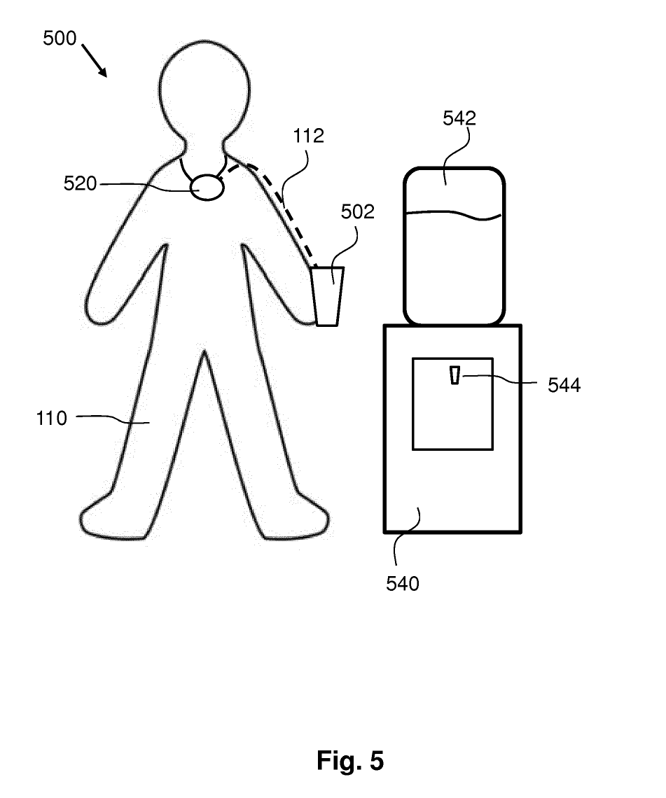

FIG. 5 schematically presents a first embodiment of the logging system 500. The logging system 500 is, in particular, useful for logging events relating to moments in time when a person 110 took water from a freestanding water cooler device 540 with a water bottle 542. It might be that a specific person 100 has to drink a lot of water because he has, for example, problems with his kidney. The logging system 500 allows the monitoring of the water intake events, and possible, logging the amount of water that has been provided to the person 110. This allows the person 110, and other persons, to check whether enough water was taken. The water cooler device 540 comprises a body coupled communication interface which has, for example, close to the water tap 544 a conductive plate for capacitively coupling to the body of the person 110 when the person taps water in his cup 502. The water cooler device 540 also has an ID which identifies either the fact that the water cooler device 540 dispenses water, or identifies the fact that the water cooler device 540 is a water cooler device, or uniquely identifies the specific water cooler device 540. The person 100 wears a logging device 520 which may be worn by the person 100 with a necklace. The logging device 520 comprises a body coupled communication interface which is configured to receive identification data via a body transmission channel 112 that follows the body of the person 110. The logging device 520 further comprises a data storage that is configured to store the received identification data. The storing of the received identification data results in creating a log of received identification data such that the log can be used to enable monitoring the intake of water by the person 110 (in so far obtained from the water cooler device 540). In summary, the logging system 500 is similar to previous discussed logging system, however, with a different that no medication is dispensed, but that drinks are dispensed.

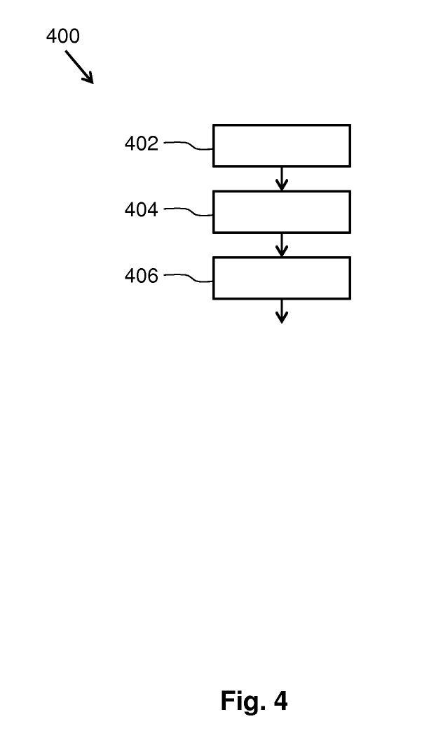

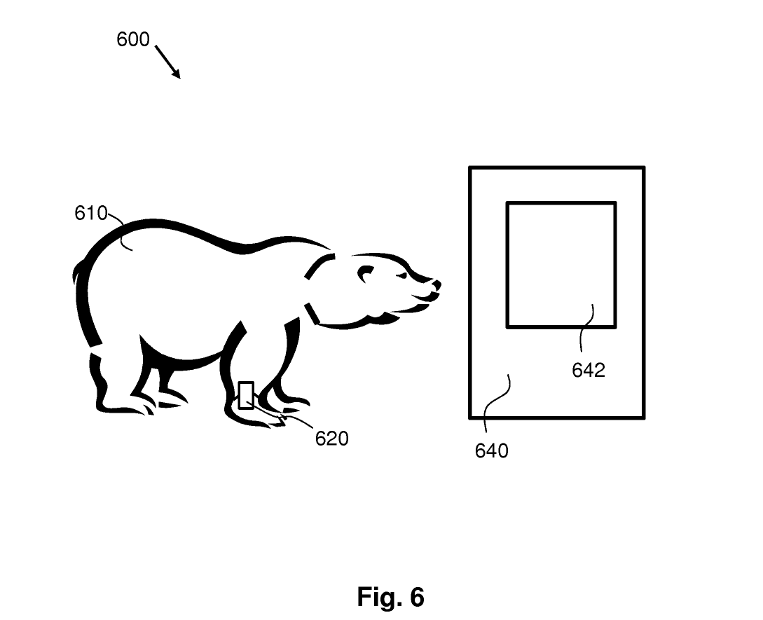

FIG. 6 schematically presents a second embodiment of another logging system 600. The another logging system 600 may be used in, for example, a zoo where animal caretakers of, for example, the bears have to monitor whether the bears 610 eat enough food that is provided in a feeding unit 640 because, otherwise, the animal caretakers have to provide additional food to the (individual) bears 610. The another logging system 600 comprises a logging device 620 which is, for example, worn by the bear 610 around his leg. The logging device 620 may be coupled with a strap around the leg of the bear 610. In another embodiment, the logging device 620 is provided with a strap around the neck of the bear 610. The logging device 620 comprises a body coupled communication interface and a data storage. The body coupled communication interface is configured to receive identification data via a body transmission channel that follows the body of the bear 610 and the logging device 620 is configured to store this received identification data in the data storage of the logging device 620 such that a log is created of events that the bear went to the feeding unit 640 to eat some food. The events may be accompanied by date and time stamps and possible other data received from the feeding unit, such as the amount of food that is consumed by the bear 610. The feeding unit 640 comprises in its front panel a hole 642 through which the bear 610 must access the food. Near the hole 642, in the feeding unit 640, an electrical conductive plate may be provided which capacitively coupled to the body of the bear 610 when the bear tries to access the space inside the feeding unit 640 by sticking his head in the hole 642. The electrical conductive plate may be coupled to a body coupled communication interface which is configured to send identification data to the logging device 620 worn by the bear 610. The identification data identifies the food that is provided by the feeding unit 640 and/or uniquely identifies the feeding unit 640. The feeding unit 640 may, for example, detect when a bear 610 tries to obtain food and at that moment in time the body coupled communication interface of the feeding unit 640 starts to communicate the identification data of the feeding unit 640 via the electrical conductive plate. The logging device 620 checks, for example, on a regular basis whether it receives via the body transmission channel some data and when it detects that it receives identification data via this transmission channel, this data is received and stored in the data storage. The feeding unit may also provide something to drink for the bear 610, or may provide, together with the food, some medication at specific moments in time. The identification data may also identify the type of liquid which is provided to the bear 610 or the type of medication that is provided together with the food. Note that this embodiment shows that the logging system is not only limited to dispensing devices that dispense medication and/or dispense drinks and that the system can also be used in relation with animals. FIG. 4 presents a method 400 of registering data for enabling monitoring of intake of a product by a user according to an intake plan. The method comprises the stages of: a) detecting 402 whether a logging device and a dispensing device are both in the close vicinity of a body of the user, b) communicating 404 identification data from the dispensing device to the logging device when both devices are in the close vicinity of the body of the user, the communicating is performed via body coupled communication interfaces being present in both devices, the identification data identifies the product being dispensed by the dispensing device or identifies the dispensing device, c) storing 406 the identification data in a data storage of the logging device. The above method may be executed in the medication adherence system 100 of FIG. 1, the medication adherence system 200 of FIG. 2, the logging system 220 of FIG. 2 and the logging system 500 of FIG. 5. The method 400 provides the same benefits as these medication adherence systems 100, 200 and logging system 500,600 and may have similar embodiments with similar effects as the corresponding embodiments of the system 100, 200.

In summary, the application provides a logging system and a method of registering data for enabling monitoring of intake of a product by a user according to an intake plan. The logging system comprises a dispensing device and a logging device. The dispensing device has identification data which identifies the device itself or identifies the product dispensed by the device. The dispensing device is able to communicate via body coupled communication. The logging device comprises a data storage and is also able to communicate via body coupled communication. When the dispensing device and the logging device are both in the close vicinity of the body of the user who carries the logging device, the identification data is transmitted via body coupled communication to the logging device which subsequently stores the received data in the data storage.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and some aspects may be implements by means of a suitably programmed computer or processor. In the device claim enumerating several means, several of these means may be embodied by one and the same item of hardware. The mere fact that certain measures are recited in mutually different dependent claims does not indicate that a combination of these measures cannot be used to advantage.

1. A logging system for enabling monitoring of intake of a product by a user according to an intake plan, the logging system comprising:
a logging device being carried by the user on or in a close vicinity of the user, the logging device comprising a first body coupled communication interface,
a dispensing device for dispensing the product to the user who operates the dispensing device by manual interaction, the dispensing device comprising a second body coupled communication interface (244) and having identification data, the identification data enabling an identification of the dispensing device or an identification of the product being dispensed by the dispensing device, wherein
the first body coupled communication interface and the second body coupled communication interface are configured to capacitive couple to the body of the user during said manual interaction for communication via a body transmission channel,
the dispensing device is configured to transmit the identification data via the body transmission channel to the logging device when the dispensing device and the logging device carried by the user are both in a close vicinity of the user during said manual interaction so that the body of the user forms the body transmission channel,
the logging device further comprises a data storage and a controller configured to receive via the first body coupled communication interface the identification data and store the received identification data in the data storage for obtaining a log of the received identification data for enabling monitoring whether the user adheres to the intake plan.

2. The logging system according to claim 1, wherein the data storage of the logging device is configured to further store the intake plan and the controller of the logging device is further configured to detect whether the user adheres to the intake plan on basis of an assessment of the received identification data in relation to the intake plan.

3. The logging system according to claim 1, wherein the logging device comprises an alerting element for alerting the user when the controller detects that the user does not adhere to the intake plan.

4. The logging system according to claim 1, further comprising a network interface for connecting to a network for allowing one or more other devices to access the data storage of the logging device or for sending a signal generated by the logging device to the one or more other devices, wherein the network interface is provided in the logging device or in a communication device that comprises a third body coupled communication interface, wherein the third body coupled communication interface is also configured to capacitive couple to a body of the user for communication via the body transmission channel.

5. The logging system according to claim 4, further comprising a remote device being configured to enable detecting whether the user adheres to the intake plan by communicating with the logging device via another network uploading the intake plan to the logging device and receiving data stored in the data storage of the logging device or generated in the logging device.

6. The logging system according to claim 5, wherein the remote device also comprises a user interface, the user interface comprising a display for presenting received data to a specific person or an input device for receiving the intake plan from the specific person.

7. The logging system according to claim 4, wherein the logging device also comprises an alarm button or a fall sensor for detecting whether the user who carries the logging device falls, the controller being further configured to send via the network interface an alarm signal to one or more remote devices when the user pushes the alarm button or when the fall sensor detects a fall of the user.

8. The logging system according to claim 1, wherein the controller of the logging device is further configured to store a time stamp with the received identification data in the data storage.

9. The logging system according to claim 1, wherein
the dispensing device comprises a dispensing sensor for sensing whether the product is dispensed,
the dispensing device is configured to provide via the second body coupled communication interface dispensing data about the dispensing of the product on a basis of information from the dispensing sensor, and
the controller of the logging device is further configured to: receive via the first body coupled communication interface the dispensing data and store the received dispensing data in the data storage.

10. The logging system according to claim 9, wherein the dispensing sensor of the dispensing device is further configured to detect which amount of the product has been dispensed and the dispensing data comprising information based on the detected amount.

11. The logging system according to claim 1, wherein
the data storage of the logging device stores a user's identification data which uniquely identifies the user who owns or carries the logging device,
the controller of the logging device being configured to provide the user's identification data to the dispensing device via the first body coupled communication interface,
the dispensing device being further configured to store access data identifying a user who is allowed to use the dispensing device receive via the second body coupled communication interface the user's identification data when the body of the user is simultaneously in the close vicinity of the logging device and the dispensing device and only dispense the product when an assessment of the received user's identification data in light of the access data reveals that the user is allowed to use the dispensing device.

12. The logging system according to claim 1, wherein
the first body coupled communication interface is configured to communicate with other devices via a body transmission channel following the body of the user when the first body coupled communication interface is in the close vicinity of the body of the user, and
the second body coupled communication interface is configured to communicate with the logging device via the body transmission channel following the body of the user when the first body coupled communication interface and the second body coupled communication interface are in the close vicinity of the body of the user.

13. The logging system according to claim 1, wherein
the dispensing device is one of: a food dispensing device, a drink dispensing device and a medication dispensing device, comprising at least one of a pill box, a medication box, an inhaler, a nebulizer, an injection device, a water cooler, a water tap, a coffee machine, a vending machine, a food distributing device,
the logging device is one of: a watch, a mobile phone, a device attached to a necklace, an implantable device for implantation in a body of the user close to a body surface.

14. A logging device for use in a logging system, the logging device being carried by a user on or in a close vicinity of the user, comprising:
a first body coupled communication interface for receiving identification data from a dispensing device for dispensing a product to the user who operates the dispensing device by manual interaction; and
a data storage, the logging device being configured to receive the identification data via a body transmission channel from the logging device when the dispensing device and the logging device carried by the user are both in a close vicinity of the user during said manual interaction so that the body of the user forms the body transmission channel, the data storage being configured to store the received identification data for obtaining a log of the received identification data for enabling monitoring of the intake of the product.

15. A dispensing device for use in a logging system and for dispensing a product to the user who operates the dispensing device by manual interaction, the dispensing device comprising:
a body coupled communication interface for transmitting data via a body transmission channel and having identification data for transmission to a logging device, the identification data enabling an identification of the dispensing device or an identification of the product being dispensed by the dispensing device, the dispensing device being configured to transmit the identification data via a body transmission channel to the logging device when the dispensing device and the logging device carried by the user are in a close vicinity of the user during said manual interaction so that the body of the user forms the body transmission channel.

16. A method of registering data for enabling monitoring of intake of a product by a user according to an intake plan, comprising:
carrying a logging device comprising a first body coupled communication interface,
operating by a manual interaction a dispensing device for dispensing the product, the dispensing device comprising a second body coupled communication interface,
capactive couple the first body coupled communication interface and the second body coupled communication interface to the body of the user during said manual interaction for communication via a body transmission channel,
detecting whether the logging device and the dispensing device are both in the close vicinity of the user during said manual interaction so that the body of the user forms the body transmission channel,
communicating, upon said detecting, identification data from the dispensing device to the logging device via the body transmission channel via the body coupled communication interfaces, the identification data identifying the product being dispensed by the dispensing device or the dispensing device,
storing the identification data in a data storage of the logging device for creating a log of the received identification data for enabling intake monitoring.
